(19) United States
(12) Patent Application Publication
(10) Pub. No.: US 2009/0236035 A1
(43) Pub. Date: Sep. 24, 2009

(54) Device for protecting container-grown seedling root systems and method for its manufacture

(75) Inventor: Roger D. Wimer, Kelso, WA (US)

Correspondence Address: ATER WYNNE LLP, 1331 NW Lovejoy St. Suite 900, PORTLAND, OR, 97209-2785, US

(73) Assignee: IFA Nurseries, Inc.

(21) Appl. No.: 12/381,952

(22) Filed: Mar. 17, 2009

Related U.S. Application Data
(63) Continuation-in-part of application No. 11/171,596, filed on Jun. 29, 2005, now abandoned.
Application No. 11/171,596 is a continuation-in-part of application No. 11/801,722, filed on May 9, 2007.

(51) Int. Cl. B32B 38/04

(52) U.S. Cl. 156/242

(57) ABSTRACT

A method of manufacturing a container-grown seedling protective device includes laying down contiguous lengths of first and second laminar sheets; positioning an array of seedlings therebetween; and sealing the first and second laminar sheets along a congruent edge thereof and along the spaced-apart seams between the seedlings to form individuated pockets, each configured to receive therein a root ball. An alternative method for manufacturing a protective device for container-grown seedlings comprises positioning a plurality of spaced rods of defined length between contiguous lengths of first and second laminar films; adhering the first and second films to form a seam along a congruent edge thereof and along plural spaced apart seams between the rods, the plural spaced-apart seams extending from the congruent edge, thereby to form a contiguous laminate; and removing the rods from between the seams to form individuated substantially sealed plural pockets.

### RELATED APPLICATIONS

The present application is a continuation-in-part of and claims priority to copending U.S. patent application Ser. No. 11/171,596 entitled PLANT SEEDLING POT AND METHOD FOR ITS MANUFACTURE, filed 29 Jun. 2005 and published as Publication No. US 2007/0000171 A1, and U.S. patent application Ser. No. 11/801,722 entitled DEVICE FOR PROTECTING CONTAINER-GROWN SEEDLING ROOT SYSTEMS AND METHOD FOR ITS MANUFACTURE, filed 9 May 2007, the disclosure contents of which are incorporated herein in its entirety by this reference.

### FIELD OF THE INVENTION

This invention relates generally to the field of protecting and nurturing seedlings. More particularly, it concerns protecting and nurturing seedlings that are container-grown and sometimes planted intact with the protective device.

### BACKGROUND OF THE INVENTION

Many plants including ornamental, reforestation tree seedlings and vegetables are grown in greenhouse nurseries. They are typically grown in containers made from an assortment of materials, sizes, and shapes. These containers usually contain cavities which are pre-formed and shaped to sizes that best fit root and shoot growth for various species. These cavities are filled with soil material or medium such as but not confined to soil, soil amendments, peat, and fertilizers. Once seeded in these containers, the plant grows to the desired size and shape, is extracted manually or by machine, packaged, and shipped to customers. Alternatively, the container-grown plant is packaged and shipped to customers inside the container in which they were grown.

Of particular interest are container-grown and unprotected tree seedlings. Often during extraction approximately six to twelve of these seedlings, depending on size, are stacked together on the packing line, wrapped together and in contact with one another within a wrap-around single poly liner sheet, boxed or bagged, and sent to a freezer facility so that the product can be stored over a long period of time safely before actual planting. During this process, these bundled trees and/or root balls typically freeze together into one large ice lump due to moisture remaining in the root system during the growing cycle. Once the planting time arrives, these frozen bundles must be thawed at the freezer site or planting site in order to separate each individual seedling for planting.

Thawing takes time and adds expense. Thawing can cause desiccation to exposed tender root systems as typically bundles thaw from the outside inward. The outer root systems are thawed long before the inside of the bundles and subjected to drying and disease of the fine root tips needed for growth. Under-thawing requires planters in the field forcibly to break apart partially frozen bundles, thereby to separate or individuate the container-grown but unprotected seedlings. The resulting damage decreases nutrients available to the new plant, structure and strength of the root medium around the initial root growth and around the root tips themselves, as those of skill in the art know. Newly planted seedlings need all the vitality possible for survival.

### SUMMARY OF THE INVENTION

A container-grown seedling protective device includes a flexible expanse including an array of plural pods, each pod in the array of pods configured for holding a container-grown seedling root ball therein. A container-grown seedling protective device includes an array of plural generally cylindrical pockets, each of the plural pockets including a closed bottom and an open top, and each of the plural pockets configured for holding a single seedling therein separate from one or more adjacent seedling root balls held by adjacent pockets, each of the plural pockets being detachably connected to an adjacent one of the plural pockets by a frangible web extending therebetween, the structure of each frangible web permitting the array of plural pockets when holding plural container-grown seedling root balls therein to be configured in a manipulable size and shape that facilitates plural-container-grown seedling handling and singular container-grown seedling dispensing from the array. A method for manufacturing a protective device for container-grown seedlings includes laying down a contiguous length of a first laminar film; positioning a plurality of spaced rods of defined length atop the length of first film; laying down a contiguous length of a second laminar film atop the first film and the spaced rods; adhering the first and the second films to form a seam along a congruent edge thereof beyond the reach of the rods and along plural spaced apart seams between the rods, the plural spaced apart seams extending from the congruent edge like teeth of a comb, thereby to form a contiguous laminate; and removing the rods from between the seams to form individuated substantially sealed plural pockets defined by the seams, the pockets being configured to receive therein root balls of container-grown seedlings.

### BRIEF DESCRIPTION OF THE DRAWINGS

FIG. 1 shows a conventional seedling packing procedure on a nursery conveyor belt.

FIG. 2 is a front elevation of the protective container seedling device, or, simply, protective device, in accordance with one embodiment of the invention.

FIG. 3 shows a front elevation featuring the perforated tear lines in contiguous sheets of the protective container seedling device.

FIGS. 4 and 5 illustrate a phased diagram of one method of producing the protective container seedling device of FIG. 2.

FIGS. 6A-6E show the protective container seedling device in five different deployed-for-use configurations. FIG. 6A shows in isometric view a plurality of seedlings within the protective device in accordance with another embodiment of the invention. FIG. 6B shows in isometric view a plurality of seedlings within the protective device in accordance with yet another embodiment of the invention. FIG. 6C shows in isometric view a plurality of seedlings within the protective device in accordance with still another embodiment of the invention. FIG. 6D shows in isometric view a two-dimensionally arrayed plurality of seedlings within the protection device in accordance with yet another embodiment of the invention. FIG. 6E shows in a somewhat simplified schematic isometric view a bundled plurality of seedlings within the protective device in accordance with one embodiment of the invention in which it is easily transported.

Detail A shows a fragmentary, bottom edgewise view of the protective device of FIG. 6A.

FIGS. 7 and 8 illustrate a phased diagram of one alternative method of producing the protective container seedling device of FIG. 2, in accordance with another embodiment of the present invention.

### DETAILED DESCRIPTION OF THE PREFERRED EMBODIMENTS

The novel protective device consists of individually formed pods on a sectional or continuous sheet in a one-dimensional (1D) or two-dimensional (2D) array. If manufactured as a continuous sheet, whether in a 1D or 2D array, the protective device can be perforated (or otherwise biased to tear or separate) along separating lines that extend longitudinally between adjacent ones of the formed pods, allowing separation of one or more pods at predetermined intervals to meet packaging needs. Indeed, perforations can be provided between each protection device and an adjacent one, thereby permitting individual dispensing and handling of containerized-seedling containing pods. Dimension and size of the sheet and pods can change to accommodate different size root systems and packaging needs and may be slightly oversized and/or tapered to ease target and thus ease insertion while gripping the seedling within the pods.

The pods on the protective device are open at the top and sealed on the three other sides allowing seedling root systems to be inserted into and removed from the protective device easily and quickly, whether frozen or unfrozen (i.e. at least partially thawed). This allows a choice for planting either frozen or thawed in the field. If the seedling is planted frozen the seedling can be removed individually from the protective device and thawing can then take place naturally in the ground. If planted unfrozen, then damage to the growing medium and resulting loss of nutrients can be avoided. This will give the newly planted seedling a better chance of survival. Moreover, the invented protective device can be planted with the seedling therein, whether frozen or unfrozen.

The sheet and pods themselves are constructed of materials that are strong enough to hold the inserted root system while packing, to permit freezing without the pod material sticking to the root system, and thus the sheet and pods can be used and/or disposed of safely.

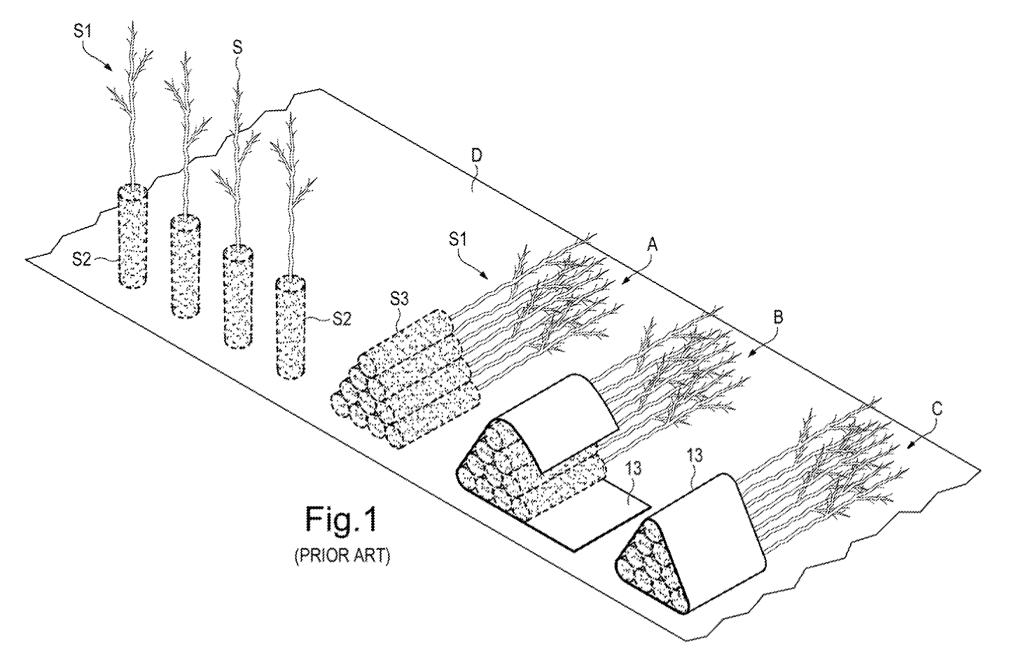

FIG. 1 shows a seedling S with a leader S1 and base root system S2 moving along a typical nursery packing belt D. Seedlings S are stacked in bundles (see phase diagram A), wrapped in a sheet of poly type material 13 (see phase diagram B and C), and boxed or bagged for shipment. Those of skill in the art know that the act of stacking and wrapping results usually in a 6″ diameter bundle of seedlings held tightly together by the taut wrapping material. In addition, those of skill in the art know that the number of seedlings per bundle typically range from approximately six to ten in year-old plant seedlings and approximately twenty to twenty-five in smaller seedlings used for transplanting into bare root nurseries to mature another year. During this bundling process, the material in which the root systems have grown is susceptible to breaking. As a result, the seedlings can lose part of their growth medium and structural support therefrom, as well as nutrient value. The bundled roots S3 freeze together when stored at freezer facilities. This creates thawing, handling, and individual seedling planting problems, as is known.

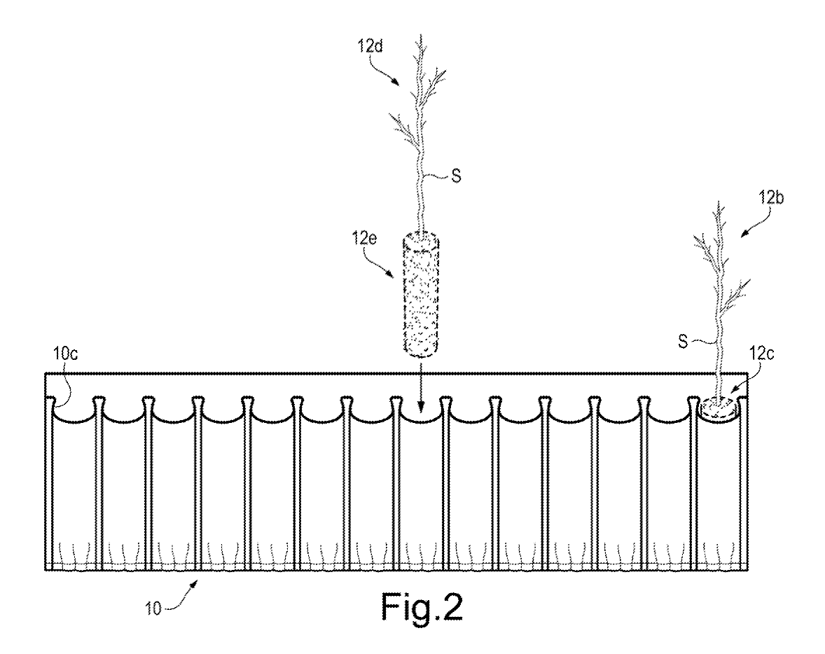

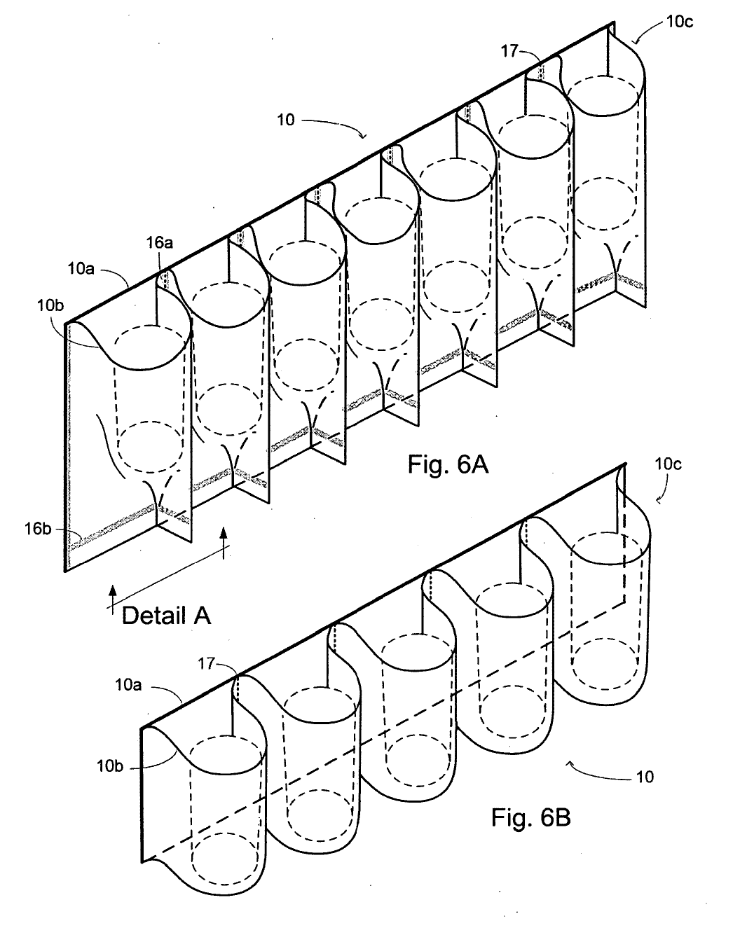

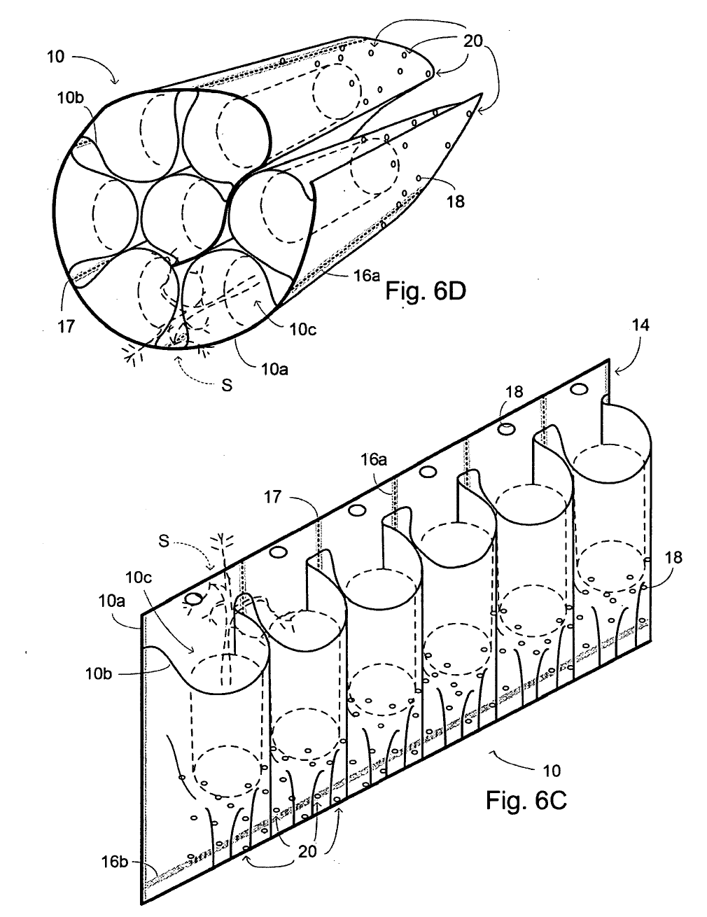

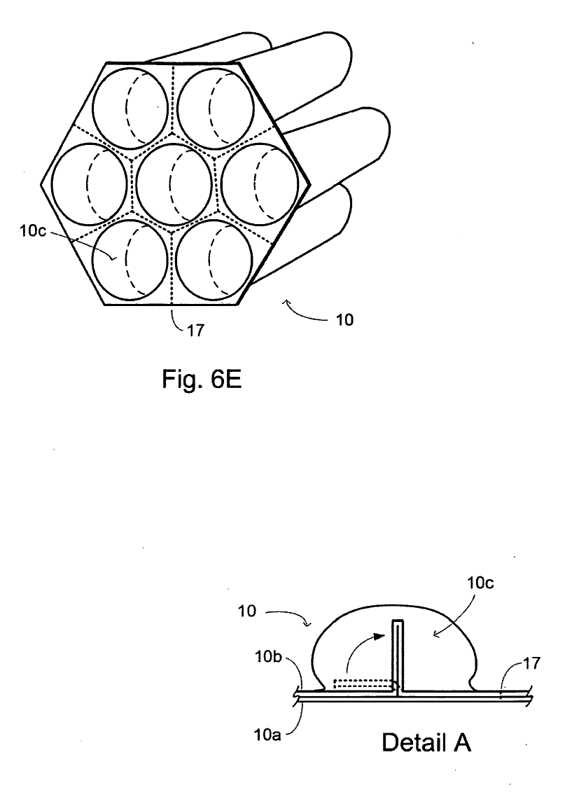

FIG. 2 shows a sheet of protective device 10 with individual formed pods 10c that are open at the top and sealed on all other sides. Protective device 10 can be any size, can include a 1D or 2D array of plural pods, and can be manufactured in an individual or continuous sheet, depending upon the type and size of seedling root system and packaging needs. Protective device 10 can be made of any suitable material depending upon weight of seedlings and disposal methods desired. An adjacent two or more of plural pods 10c preferably are joined to one another by a frangible (breakable) web for easy dispensing of one or more pods from the remaining pods. Pods 10c themselves optionally can be perforated in at least a lower region thereof or alternatively over the entirety thereof to promote moisture and/or nutrient migration from the planting soil to the container-grown, pocket-protected seedling. Refer briefly to FIGS. 6A-6E.

Pods 10c are generally cylindrical in shape, and can be in accordance with one embodiment of the invention approximately circular in cross section. Alternatively, within the spirit and scope of the invention, pods 10c can be octagonal, hexagonal, square, triangular, or any other suitable cross sectional shape, whether regular polyhedral or not. Alternatively, within the spirit and scope of the invention, pods 10c can have a generally cylindrical upper portion, e.g. half, smoothly joined, e.g. at approximately half of the overall height of the pods with a generally frusto-conical lower portion, e.g. half. Thus, any suitable shape for receiving and protecting a seedling is contemplated as being within the spirit and scope of the invention.

Typically, a container-grown seedling's root ball is approximately 4-6″ in height, and the seedling overall including the root ball is between approximately 6″ and 16″ in height. Thus, in accordance with one embodiment of the invention, the pods 10c are between approximately 6″ and 7″ in height, leaving between an approximately 0.5″ and 2″ high protective rim extending above the upper surface of a typical seedling root ball. (Refer briefly to FIGS. 6A-6E.) Finally, pods 10c are between approximately 1″ and 3″ in diameter, dimensioned to receive seedlings of various root ball diameters.

One suitable material for protective device 10 in its first 1D plural-pod array embodiment shown in FIGS. 6A and 6C is approximately 1-3 mil poly-nylon film or other suitable thickness and material. Thus in accordance with this embodiment of the invention, each of the two laminar sheets of material is referred to as having a single-laminate, bi-material character. (One side of a poly-nylon film is poly and the other is nylon. The two single-laminate, bi-material sheets are placed together with their poly surfaces facing inwardly and their nylon surfaces facing outwardly.) In a second 1D molded, plural-pod array embodiment shown in FIG. 6B, the material can be polypropylene film. In a third 2D plural-pod array embodiment shown in FIG. 6E, the material can be a polystyrene film or so-called “pulp backing” (similar to egg carton material) that is blow- or vacuum-molded. In alternative embodiments, polystyrene, poly lactic acid (PLA), or other polymer and preferably biodegradable or compost-able sheet materials can be used, whether in laminar sheet configurations or blow- or vacuum-molded. (Those of skill in the art will appreciate that PLA is compostable and thus can be left in the ground without adverse environmental impact.)

Other suitable materials are contemplated as being within the spirit and scope of the invention. For example, paper stock can be used, as can cloth, e.g. burlap, muslin or other lightweight fabric, whether woven or unwoven, e.g. extruded or pressed as from a slurry or pulp. The material from which protective device 10 is made can be infused with fertilizer, vitamins, nutrients, etc. to enhance the nurturing of the seedling that is planted while still inside its pod 10c.

Thus, any combination of materials, sizes, pod shapes or numbers, and 1D or 2D pod array configurations within a container-grown seedling protective device is contemplated as being within the spirit and scope of the invention. Some such alternatives are described and illustrated herein, but such are not intended to limit the scope of the invention.

Those of skill in the art will appreciate that, although not shown in the drawings in the interest of clarity, nevertheless one or more pods 10c can be infused or impregnated with fertilizer, nutrient, moisture, or other nutritional additives to encourage early growth of one or more seedlings especially when planted intact within the one or more corresponding pods. Such can be accomplished at any appropriate stage of manufacturing the pods or the protection device arraying the pods therein, and the recipe for such additive can vary depending upon variety and/or geography of the seedling and planting site. For example, with burlap material to form the pods, the burlap when it is in individual sheet form can be conveyed contiguously through a nutritional additive bath concentration and then dried as by heating to trap the entrained additive particulate within the woven burlap fabric. Those of skill in the art will appreciate that alternative materials can be similarly or differently infused with nutritional additive particulate.

Those of skill in the art also will appreciate that seedlings can be planted intact with the pods arrayed within the protective device, within the spirit and scope of the invention. This is facilitated in accordance with one embodiment of the invention by providing perforated tear lines, or frangible webs, between each individual pod and an pod adjacent thereto. The fine root hairs readily penetrate the material wall, especially when aided by the perforations, and early obtain nutrients from the soil. In the case the material the pods are made from itself is quickly biodegradable or at least compostable, as described above, there is no environmental harm to planting the seedlings intact within their respective and separately and easily dispensable pods, in accordance with the invention.

Those of skill also will appreciate however that, in accordance with another embodiment of the invention, only selected ones of webs extending between adjacent pods might be perforated or rendered frangible, thereby preventing individual dispensing of pods while enabling group dispensing of a given number of pods at a time, from which group of pods individual seedling root balls can be removed and individually planted.

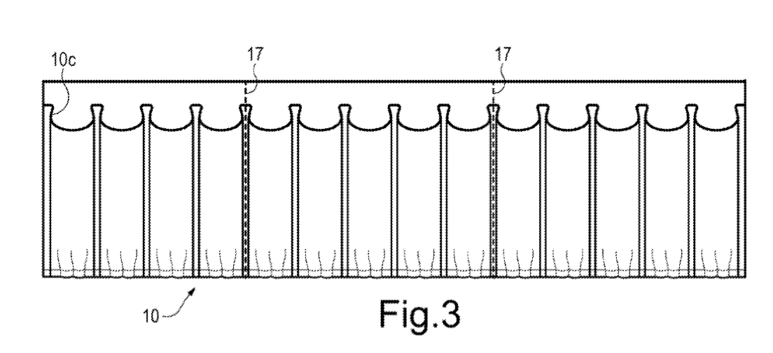

FIG. 3 shows protective device 10 with frangible webs between adjacent pods, the frangible webs in accordance with one embodiment of the invention taking the form of vertical expanses along which extend adhered seams 16a, the vertical expanses including perforated linear tear joints 17. Thus the combination of vertical expanses and perforated linear tear joints form what are referred to herein as frangible webs. The perforated tear joints 17 allow individual desired one or more pods to be detached from the remainder within protective device 10 to meet packaging, handling and dispensing needs.

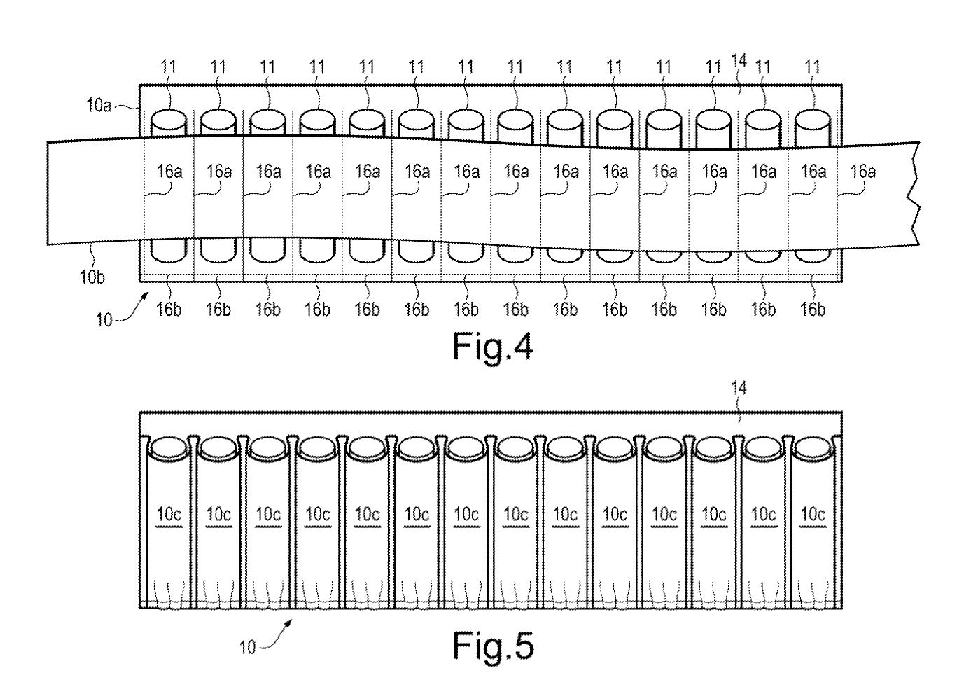

FIGS. 4 and 5 show one method of manufacturing protective device 10.

As those skilled in the art know, there are several methods of manufacturing the protective device 10 not limited to the method disclosed. By this method, forming rods 11 are positioned over sheet 10a and a second flat sheet 10b overlays the rods. (See FIG. 2.)

First and second sheets 10a and 10b are sealed together at locations 16a and 16b by a die-stamp or equivalent tool that utilizes a calibrated and repeatable combination of heat and pressure in a form (so-called “knives” not shown for the sake of clarity but known to those of skill in the art) that seals the first and second laminar sheets together along both side seams 16a surrounding each pod (one of which can be a seam shared with an adjacent such pod) and that also seals the first and second laminar sheets together along a lower contiguous seam 16b. After an appropriate time period under such heat and pressure, the die-stamp or equivalent tool is removed from the contiguous, sealed laminar structure. (See FIGS. 3 and 4.)

Those of skill in the art will appreciate that with poly-nylon sheets, the inner poly surfaces face one another but the outer nylon surfaces oppose one another. This provides adherence of the two sheets together along the intended seams by the application of heat and pressure, but it does not result in adherence of the two outside surfaces together. Refer briefly to FIG. 6A and Detail A. The freezer-friendly nylon outer does not stick to the storage container or another device or pod. The freezer-friendly poly inner does not stick to the plant seedling or root ball. Thus, dispensing of one or more seedling root balls from one or more pods is easier and quicker.

In accordance with one embodiment of the invention shown in FIG. 6C, second sheet 10b is slightly shorter in height than first sheet 10a, thus leaving an area at the top of sheet 10a to be used as a handling tab 14 during seedling insertion, transport, and dispensing. Those of skill in the art will appreciate that tab 14 can be equipped with one or more through holes 18 approximately centered above one or more of pods 10c, as illustrated, to facilitate hanging (e.g. on a hook or an overhead conveyor or shelf) a length of device 10 during such handling thereof. Also those of skill in the art will appreciate that handling tab 14 facilitates insertion of one or more seedling root balls into one or more pods 10c because the upper edges of the laminar sheets 10a and 10b have vertical separation of between approximately 1″ and 1½″. This separation or vertical upper edge gap makes it easier to form a generally circular opening by insertion therein of, for example, one or more fingers and a thumb. Those of skill in the art will appreciate that such a tab or handle can be incorporated into alternative embodiments of the invention as well, e.g. those embodiments shown in FIGS. 6A, 6B, 6D and 6E and others that are contemplated as being within the spirit and scope of the invention.

Once the rods are removed, the pods generally retain their shape by virtue of their structural and material makeup. More importantly, the size of each of forming rods 11 is selected to match the size of a seedling root system to be inserted into pods 10c formed thereby, and those of skill in the art will appreciated that the size can be selected to accommodate seedling root systems of varying sizes.

FIG. 2 illustrates an example of two seedlings 12b and 12d being inserted into protective device 10. Once inserted into protective device 10, root systems 12c and 12e are substantially completely sealed off from each other and any other protected root systems. This allows seedlings 12b and 12d within protective device 10 to be extracted therefrom, as illustrated, and planted individually.

FIGS. 6A, 6B, 6C, 6D and 6E show the invented protective device in five different embodiments that represent alternative but easily transported, handled and dispensed configurations. FIG. 6A shows a first embodiment of the invention in which sheets of poly-nylon are laminated with a lower edge forming a double-fold in the outer laminar that extends outwardly away from the inner laminar to produce seven slightly tapered but generally cylindrical pods 10c. FIG. 6B shows a second embodiment of the invention in which device 10 is molded to produce five generally cylindrical pods 10c. It will be appreciated by those of skill in the art that the embodiments shown in FIGS. 6A and 6B for the sake of clarity do not include perforations or holes in a defined density in a lower region thereof for encouraging moisture and nutrients to permeate the root ball from the soil. It will also be appreciated that FIGS. 6A and 6B for the sake of clarity and simplicity also do not include upper edge tabs or handles. It will be understood that such is contemplated as being within the spirit and scope of the invention. Finally, it will be appreciated that FIGS. 6A and 6B do not show seedlings but instead, in the interest of clarity, show only root balls in dashed outline.

FIG. 6C shows a third embodiment of the invention similar to that of FIG. 6A, but with an apertured and perforated tab or handle 14 along the upper edge of a longer rear laminar sheet, with a gathered or pleated and planar lower edge that forms six slightly tapered but generally cylindrical pods 10c, and with small random or patterned perforations or through holes 20, for example (see FIGS. 6C and 6D) in a lower region of device 10 and each pod 10c arrayed therein. FIG. 6D shows a spiral, rolled-up bundle or generally cylindrical configuration of plural pods 10c of protective device 10 corresponding, for example, with the embodiment shown in FIG. 6A. Finally, FIGS. 6C and 6D show a typical seedling S including a leader extending from its root ball protected within its pod or pocket 10c.

Those of skill in the art will appreciate that such a conveniently dimensioned and configured bundle can be easily carried by hand, e.g. under one arm or slung on a rope near the waist or slung over the shoulder on a strap or strung or hooked with a tether onto a belt or belt loop, etc. Those of skill in the art also will appreciate that those embodiments of the invention illustrated in FIGS. 6B and 6C also might be so configured, at least to the extent of the flexibility of their materials and structures. This is a virtue of the 1D layout of the plural pods along an elongate axis defining an elongate relatively flexible expanse capable of being curved and/or folded even when each pod therein contains a container-grown seedling root ball.

Those of skill in the art also will appreciate that protective device in any suitable form as described and illustrated herein alternatively can be simply left in its normal flat expanse form for further deployment including storing, transporting and dispensing therefrom. For example, one or more of the illustrated planar array embodiments of FIGS. 6A, 6B, 6C and 6E can be stacked and bundled with a cord or twine, can be stacked n-high or n-wide (wherein n is the number of individual arrays) and bundled within a cardboard box or other storage or dispensing container. Thus, FIG. 6D illustrates only one possible “bundling” configuration among myriad bundling and multiplying (e.g. stacking) possibilities. The ability to dispense a group of pods (m) in arrays (n) in a bundle is an important advantage of the invented linear perforation 17 or other treatment that enables the user free choice in how many pods (m) and how many arrays (n) are dispensed for most convenient handing. All suitable means for configuring one or more such protective devices for ease of handling are contemplated as being within the spirit and scope of the invention.

Detail A shows the lay-up of the laminar sheets of the embodiment of device 10 shown in FIG. 6A. Those of skill in the art will appreciate that the drawing is not to scale. Indeed, the thickness of the laminar films is intentionally greatly exaggerated for the sake of clarity. It will be understood that the outer laminar sheet of greater length is adhered with a fold to the inner laminar sheet of shorter length, effectively forming a pleated structure that adds depth to each formed pocket or pod 10c. This is possible using standard die stamp/press or other suitable tools to heat cure the facing inner poly surfaces while leaving the opposing outer nylon surfaces un-adhered. Detail A also shows one of the linear perforations 17 between adjacent pods 10c.

Referring still to Detail A, the die stamp/press step suggested by dashed lines shows that the folded-double outer laminar sheet may be folded flat against the singular inner laminar sheet. When the heat/pressure application is complete, and when the die stamp or other suitable tool (not shown) is removed, the folded-double (inner surfaces-adhered because poly is relatively heat and pressure sensitive) extent of the outer laminar sheet pops out (outer surfaces un-adhered because nylon is relatively heat and pressure insensitive) at generally a right angle to the plane of the inner laminar sheet, as shown in solid lines. Thus, the second or outer laminar sheet 10b is gathered and effectively pleated along its bottom edge to form generally cylindrical pockets between the un-gathered, un-pleated upper region of second laminar sheet 10b and flat inner laminar sheet 10a. This can best be seen by reference to FIGS. 6A and/or 6C.

FIG. 6E shows yet another embodiment of the invention that is referred to herein as a 2D array of separable pods 10c. The term 2D refers of course to the fact that the array is more than one wide in any dimension. In the illustrated embodiment, it may be seen that seven pods 10c are provided in a dense array wherein the elongate axis of the pods are parallel with one another and are perpendicular to the plane of the array. Such a 2D protective device 10 can be made by molding polystyrene, PLA or pulp backing material in sheet or slurry form by any suitable molding technique, e.g. blow-molding, vacuum-molding, molding in general accordance with the teachings of the above-referenced co-pending patent application, etc. Such a 2D protective device 10 can be of any suitable planar dimension, 2D configuration, depth, or pod array configuration or size, all within the spirit and scope of the invention.

As may be appreciated by those skilled in the art, a method for manufacturing a protective device 10 of FIG. 2 for container-grown seedlings is not limited to the embodiments disclosed above, in which an array of rods are placed and positioned between the first and the second laminar films before forming an array of root ball-shaped pockets. After forming the root ball-shaped pockets, the rods are removed to enable those formed pockets to receive plural container-grown seedlings. As disclosed in the following paragraphs, a method for manufacturing a protective device for container-grown seedlings comprises laying down contiguous lengths of a first and a second laminar films and placing between the first and the second laminar films an array of objects that can be configured generally or substantially like container-grown seedlings. The objects configured generally like container-grown seedlings include the container-grown seedlings themselves, in addition to those seedling-container configured objects such as rods, tubes, seed vessels, compartments, cells, capsules and enclosures. Those seedling-container configured objects are used to form seedling-shaped pockets to receive the root balls of container-grown seedlings. By a general definition, the term root ball may include the roots and the soil that surrounds them, or as broadly used in the industry and understood by those skilled in the art, the term may also be used to describe a root ball plus a lower potion of the trunk that is integrated with the root ball.

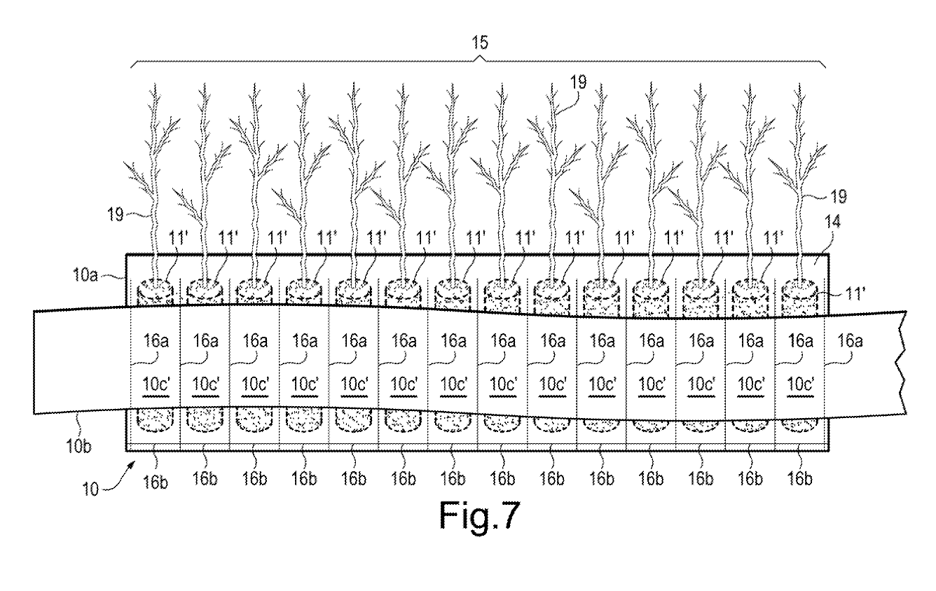

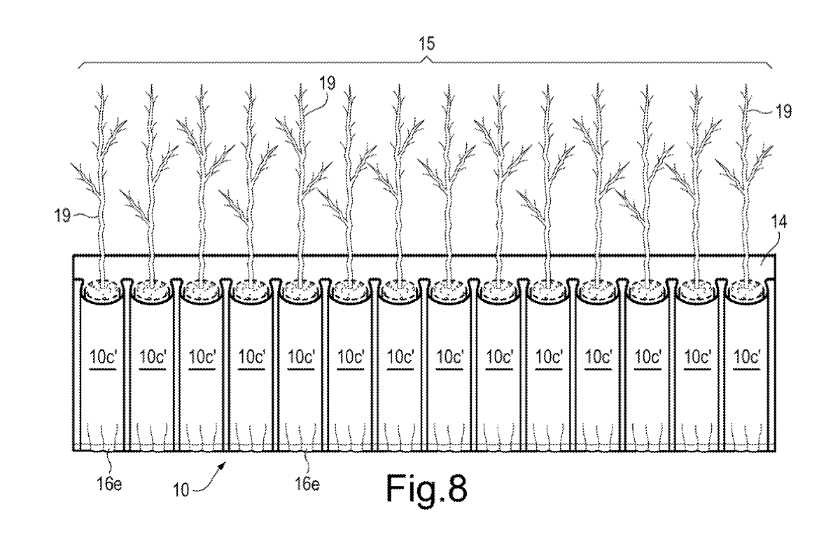

In embodiments of the present invention with reference to FIGS. 7 and 8, a method of manufacturing may be implemented to produce protective device 10 of FIG. 2 for container-grown seedlings. In an alternative embodiment of the present invention, an automated packing mechanism may be integrated to a seedling packaging and handling process to systemize the packaging process. As those skilled in the art would appreciate it, an array of container-grown seedlings, for example, an exemplary array 15 of seedlings 19 as shown in FIGS. 7 and 8, may be handled by a stock packaging machine (not shown), when those container-grown seedlings are being processed for further packaging, stocking and transplanting). The exemplary array 15 of seedlings 19 with their seedling containers marches down a conveyor belt, for example, a typical nursery packing belt D as shown in FIG. 1, for packaging. Each of those plural seedlings 19 rooted in a container, therefore, is placed in a pocket with its original seedling container. As may be understood by those skilled in the art, contain-grown seedlings 19 may be also processed and packaged with their root balls only without the company of their original seedling containers.

As illustrated in FIG. 7, a protective root system 11′ may be designed and configured to container-grown seedlings 19 to shield their roots from damages, although root system 11′ may come in any form or configuration. With the top of plural container-grown seedlings 19 pointing to the same direction and their root balls to the same opposite direction, a predetermined number of container-grown seedlings 19 with a root system 11′ forms an array 15.

In an embodiment with further reference to FIG. 7, a predetermined contiguous length of first laminar sheet (i.e., a film) 10a being fed from a spool (not shown) associated with the stocking packaging machine is made ready to receive the array of seedlings 19. First laminar sheet 10a may comprise a poly surface and an opposite nylon surface. The nylon surface would function as a shield for the seedlings to protect them from exposure to the severe outdoor elements such as sun, rain, snow or ice, while the poly material with a porous structure of the opposite surface would continue to assist maintaining and nursing the seedlings prior to their transplanting.

Continuing with reference to FIG. 7, when being laid down, the nylon surface of first sheet 10a is made face down and the opposite poly surface is made face up and ready to receive an array of plural seedlings 19 with a root system 11′. Each seedling 19 with a size substantially similar to that of its neighbors in array 15 is then placed and positioned within their individual containers on the poly surface of first sheet 10a. The upper portion of seedlings 19 with branches may be placed and positioned beyond the top edge of first laminar sheet 10a and substantially beyond its handling tab 14.

Further referencing FIG. 7, a second laminar sheet (i.e., a film) 10b with substantially the same length as that of first sheet 10a may be output from a second spool associated with the stock packaging machine (not shown), after the array of seedlings 19 are positioned on first laminar sheet 10a. As may be understood by those skilled in the art, second laminar sheet 10b may be fed from the spool that outputs first laminar sheet 10a in the same manner. The second laminar sheet 10b may also comprise a poly surface and an opposite nylon surface as does first laminar sheet 10a. When being fed from the spool, the poly surface of second laminar sheet 10b is made face down, and the nylon surface thereof is made face up. When fully settled, second laminar sheet 10b overlays those seedlings 19 within their containers 11′ in array 15 that rest on the poly surface of first laminar sheet 10a. Thus, the respective poly surfaces of first and second laminar sheet 10a and 10b are made to face one another and surround the array of seedlings 19 with their root systems 11′. The first and second laminar sheets 10a and 10b then define an array of unsealed yet individuated pockets 10c′, each housing an individual seedling 19 with its root ball within or without a container. In some embodiments, fertilizer or other organic materials may be also infused and stuffed into pockets 10c′ to assist seedlings 19 to increase growth and survivability following transplanting.

Further referring to FIGS. 7 and 8, first and second sheets 10a and 10b are adhered and sealed together at locations 16a and 16b by a die-stamping or an equivalent tool that utilizes a calibrated and repeatable combination of heat and pressure in a form (so-called “knives”, not shown, but known to those of skill in the art) that defines an array of contiguous yet individuated packaging pods 10c′. The die-stamp or equivalent tool may be positioned to define and seal first and second laminar sheets 10a and 10b along a lower contiguous seam 16b beyond the reach of the root balls of seedlings 19. The congruent seam 16b creates a supporting edge to provide a general spacer or cushion for an array of plural seedlings 19 with their root balls in containers 11′. The first and second laminar sheets 10a and 10b are also sealed together along both side seams 16a surrounding the lower portion of seedlings 19 and their root system 11′ (one of which can be a seam shared with an adjacent such pod) to form an array of plural individuated pockets (i.e., pods) 10c′ of a predetermined size. Within each individuated pocket 10c′ of the array lies a container-grown seedling 19 with or without its root ball in a container, with each seedling 19 maintaining a predetermined safe distance from its neighboring seedlings in array 15.

In embodiments of the present invention, referring to FIGS. 2 through 8, the stock packaging machine used to implement the method of manufacturing disclosed hereby may be equipped with a heat chamber that maintains a predetermined temperature. When an array of unsealed pockets 10c′ passes through the heat chamber through a heat tunnel, the molecules in the poly material for laminar sheets 10a and 10b react to the heat applied and rearrange to reshape the sheets. As a desired result, the reshaped sheets 10a and 10b surround individual seedlings 19, mainly the lower portion with their root balls 11′ within or without a container respectively, and define the distance between neighboring seedlings with substantial accuracy. In another embodiment, a separate heat-generating tool or some equivalent, such as a thermal blower, which is independent of the stock packaging machine, may be used to apply the heat to first and second sheets 10a and 10b at a predetermined temperature level for the same desired result.

In one embodiment, the die-stamp or equivalent tool may be operably positioned to define and produce an array of those packaging pockets 10c′ with U-shaped equilateral edges, while sealing the first and second laminar sheets 10a and 10b along both sides of seam 16a. In another embodiment, the tool may be operably positioned to define and produce an array of packaging pods 10c′ with a trapezoidal V-shape so that the root balls of seedlings 19 with root system 11′ can be tightened within pods 10c′ to prevent any incidental slippage of root balls 11′ or seedlings 19.

In an embodiment with reference to FIG. 8, one or more perforations may be punched or otherwise produced between segmented lengths of the adjacent formed pockets 10c′ to facilitate dispensing of one or more pockets from the continuous laminate. For example, when one or more seedlings are needed, the perforated segments allow a ready division and separation of the needed pockets from array 15. In addition, further reference to FIG. 8, each pocket may be perforated at least in a lower region 16e to permit and promote permeability of moisture and nutrient therethrough from soil when seedlings 19 are planted.

When an array of plural seedlings 19 is packaged in such a protective device as illustrated by FIGS. 7 and 8, those seedlings can be readily rolled up for storing and/or shipping, or be unrolled for out-planting. As those skilled in the art may appreciate that, this novel method of manufacturing a protective device, with reference to FIGS. 7 and 8, makes it unnecessary to use a plurality of individual rods 11 to form the container-configured pockets for container-grown seedlings. (See FIG. 2.) It may also become unnecessary to employ a mechanism that positions the rods atop the first film before the pocket forming and removes those rods after the forming so that those formed pockets can receive the root balls of plural seedlings. This novel method of manufacturing a protective device makes container-grown seedlings packaging process become time-efficient because an automated machine-ready procedure can be utilized. It also makes seedlings packaging process become cost-efficient because of its calculability and flexibility which reduce damages to seedlings during the packaging process. As those of skill in the art will appreciate it, there are several methods of manufacturing the protective device 10 not limited to the method disclosed hereby.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

From the foregoing, those of skill in the art will appreciate that several advantages of the present invention include the following.

The present invention provides for the protected storage, transportation, handling, dispensing, and planting of container-grown seedlings from a roll thereof, as well as a convenient method of manufacturing a protective device for such seedlings. The protective device's plural but separable pockets or pods separate and separately protect each individual seedling placed therein in the form of a flexible expanse that can be flat during manufacture and loading but that can be in a suitable, manipulable configuration when used for seedling transportation, storage, handling, dispensing, and even planting. The device can be infused with fertilizer or other nutrients, so that an intact seedling-within-a-pocket can be planted as it is dispensed from the roll. The individual pods also can be perforated in at least a bottom region thereof to enable easier migration of moisture and nutrients from the soil in the case of such intact plantings. Each pocket or pod sealingly separates (i.e., seals and separates) a corresponding seedling from every other so that, when stored, transported, or planted while still frozen, nevertheless the individual seedlings are easily separated rather than forming a solid or semi-solid, difficult-to-separate-without-seedling-damage, frozen mass.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

Finally, those of skill in the art will appreciate that the invented method, system and apparatus described and illustrated herein may be implemented in software, firmware or hardware, or any suitable combination thereof. Preferably, the method system and apparatus are implemented in a combination of the three, for purposes of low cost and flexibility. Thus, those of skill in the art will appreciate that embodiments of the methods and system of the invention may be implemented by a computer or microprocessor process in which instructions are executed, the instructions being stored for execution on a computer-readable medium and being executed by any suitable instruction processor.

The device for protective container-grown seedling root systems and method for its manufacture are generally illustrated in FIGS. 2-8, which are simplified to avoid obscuring an understanding of the embodiments with excess detail and where those skilled in the art can readily understand its structure and functionality by way of the drawings and associated disclosure.

1. A method for manufacturing a protective device for container-grown seedlings, comprising:
providing a first contiguous sheet of laminar film having a first face, and a second contiguous sheet of laminar film likewise having a first face and further having a greater length than the first sheet;
placing the respective first faces of the first and second sheets into an adjacent face-to-face arrangement with one another;
collapsing the second sheet longitudinally relative to the first sheet and forming a generally corrugated configuration; and
adhering together the first and second sheets including forming a seam along a congruent longitudinal edge thereof, the adhering further including forming plural spaced-apart seams extending from the congruent edge and individuating a plurality of pockets defined by the congruent and plural spaced-apart seams, each of the pockets being configured with an open end to enable insertion therein of an object configured generally like a portion of a container-grown seedling, and wherein a first plane extending through approximate longitudinal centers of a plurality of adjacent pockets and a second plane extending between the first and second sheets at the plural spaced-apart seams are offset relatively parallel planar with respect to one another.

2. The method of claim 1, wherein the object configured generally like a portion of a container-grown seedling is a root ball of a container-grown seedling.

3. The method of claim 1, wherein the object configured generally like a portion of a container-grown seedling includes one or more of a root ball-configured rod, container, tube, seed vessel, compartment, cell, capsule, an enclosure for a container-grown seedling, or any combination thereof.

4. A method for manufacturing a protective device for container-grown seedlings, comprising:
providing a first contiguous sheet of laminar film having a first face, and a second contiguous sheet of laminar film likewise having a first face and further having a greater length than the first sheet;
positioning an arrangement of plural container-grown seedlings at the first face of the first sheet;
placing the respective first faces of the first and second sheets into an adjacent face-to-face arrangement with one another with the arrangement of container-grown seedlings interposed therebetween;
adhering together the first and second sheets including forming a seam along a congruent longitudinal edge thereof and further including forming plural spaced apart seams extending from the congruent edge and individuating a plurality of pockets defined by the seams, each of the pockets being configured with an open end enabling removal of a container-grown seedling therefrom, wherein a first plane extending through approximate longitudinal centers of a plurality of adjacent pockets and a second plane extending between the first and second sheets at the plural spaced-apart seams are offset relatively parallel planar with respect to one another.

5. The method of claim 4, wherein the adhering includes applying heat.

6. The method of claim 5, wherein the adhering includes applying pressure.

7. The method of claim 6, wherein the first and second sheets each are formed with a poly first face, and the first and second sheets each further include an opposing nylon second face.

8. The method of claim 4, wherein the individuated plural pockets are formed where one or more of the plural seedlings are positioned, and further comprising:
die stamping the adhered first and second sheets to produce perforations between segmented lengths of the pockets, thereby to facilitate dispensing of one or more pockets from the protective device.

9. The method of claim 4, which further comprises:
perforating each pocket at least in a lower region thereof to promote permeability of moisture and nutrients therethrough from soil when such seedlings are planted.

10. The method of claim 8, wherein the die stamping includes forming the one or more pockets in an equilateral U-shape.

11. The method of claim 8, wherein the die stamping includes forming the one or more pockets in a trapezoidal V-shape.

12. The method of claim 4 which further comprises:
infusing at least one of the first and second sheets with fertilizer or the like.

13. A method for manufacturing a protective device for container-grown seedlings, the method comprising:
laying down a contiguous length of a first laminar film;
positioning a plurality of spaced objects of defined length and configured generally like container-grown seedlings atop the length of first film;
laying down a contiguous length of a second laminar film atop the first film and the spaced objects;
adhering the first and the second films and forming a contiguous laminate, the adhering including forming a seam along a congruent edge thereof beyond the reach of the objects and further forming plural spaced apart seams between the objects and extending away from the congruent edge; and
removing the objects from between the seams to form individuated substantially sealed plural pockets defined by the seams, the pockets being configured to receive therein root balls of container-grown seedlings, wherein a first plane extending through approximate longitudinal centers of a plurality of adjacent pockets and a second plane extending between the first and second sheets at the plural spaced-apart seams are offset relatively parallel planar with respect to one another.

14. The method of claim 13, wherein the adhering includes applying heat.

15. The method of claim 14, wherein the adhering includes applying pressure.

16. The method of claim 13, wherein the first and second films each are formed with a poly surface and an opposing nylon surface, and wherein the laying down of the first and second films is with their respective poly surfaces facing one another.

17. The method of claim 13, wherein pockets are formed where rods were, which further comprises:
die stamping the adhered first and second films to produce perforations between at least some of the adjacent formed pockets, thereby to facilitate separating one or more pockets from the contiguous laminate.

18. The method of claim 13, wherein the rods are generally cylindrical.

19. The method of claim 13 which further comprises:
perforating each pocket at least in a lower region thereof to promote permeability of moisture and nutrients therethrough from soil when such seedlings are planted.

20. The method of claim 13 which further comprises:
infusing at least one of the first and second films with fertilizer or the like.
